(19) United States
(12) Patent Application Publication
(10) Pub. No.: US 2021/0159750 A1
(43) Pub. Date: May 27, 2021

(54) ELECTRIC COMPRESSOR

(71) Applicant: SANDEN HOLDINGS CORPORATION, Isesaki-shi, Gunma (JP)

(72) Inventor: Tomokazu NARUTA, Isesaki-shi, Gunma (JP)

(21) Appl. No.: 16/771,844

(22) PCT Filed: Nov. 15, 2018
(86) PCT No.: PCT/JP2018/042249

§ 371 Date: Jun. 11, 2020

(30) Foreign Application Priority Data
Dec. 22, 2017 (JP) 2017-246021

(51) Int. Cl. H02K 3/40; H02K 1/14; H02K 3/30; H02K 3/32; H02K 3/52; F25B 31/02; B60H 1/32

(52) U.S. Cl. CPC H02K 3/40; H02K 1/146; H02K 3/30; H02K 2203/12; H02K 3/522; F25B 31/026; B60H 1/3222; H02K 3/325

(57) ABSTRACT

An electric compressor capable of preventing electrical discharge occurring between a coil and a stator core without increasing the size of the overall electric motor for driving a compression mechanism of the electric compressor, is provided. The electric motor of the electric compressor has a cylindrical stator, and a rotor arranged radially inside the stator. The stator includes: a stator core 52 including an annular yoke portion 52B, and multiple tooth portions 52A projecting radially inward from an inner peripheral surface of the yoke portion 52B, and arranged at predetermined intervals in a circumferential direction; a bobbin-shaped insulator 54 removably fitted on each of the multiple tooth portions 52A; a coil 56 wound around the insulator 54; and an insulating member 58 for covering an outer surface of the coil 56 in a wound state.

### TECHNICAL FIELD

The present invention relates to electric compressors for use in compression of refrigerants in air conditioners for vehicles.

### BACKGROUND ART

This type of electric compressor typically includes a compression mechanism that compresses a refrigerant of a vehicle air conditioner, and an electric motor that drives the compression mechanism. For the electric motor, an electric motor described in Patent Document 1 is known. The electric motor described in Patent Document 1 is an inner rotor type in which a rotor is arranged radially inside a cylindrical stator. The stator includes: a stator core including a cylindrical yoke portion, and multiple tooth portions projecting radially inward from an inner peripheral surface of the yoke portion, and arranged at predetermined intervals in a circumferential direction; a bobbin-shaped insulator fitted on each tooth portion; and a coil wound around the insulator.

The insulator includes: a prismatic tubular body portion that is open at opposite ends, and is configured to fit on each tooth portion; an outer flange portion formed over the entire periphery of an opening at one end of the body portion, and located at a portion corresponding to a radial outer (proximal) portion of the tooth portion; and an inner flange portion formed over the entire periphery of an opening at the other end of the body portion, and located at a portion corresponding to a radial inner (distal) portion of the tooth portion.

### REFERENCE DOCUMENT LIST

### Patent Document

Patent Document 1: JP 2016-96579 A

### SUMMARY OF THE INVENTION

### Problem to be Solved by the Invention

Since higher voltage batteries for vehicles, such as electric vehicles or hybrid vehicles, have been developed, relatively high voltages are applied to electric motors for electric compressors. In such an electric motor, it is required to secure a longer clearance for electrically insulating conductive members, such as a coil and a stator core, or in particular, a longer creepage distance, which is a shortest distance between conductive members along a surface of an insulating member.

There is concern in the electric motor described in Patent Document 1 that, since the outer surface of the coil wound around the insulator is exposed, the creepage distance between the coil and the stator core may be insufficient to secure a required electrical isolation, when a relatively high voltage is applied to the electric motor. If the creepage distance is insufficient, there may occur electrical discharge which is a flow of a current along the surface of the inner flange portion between the outer surface of the coil and the tip of the tooth portion, or electrical discharge which is a flow of a current along the surface of the outer flange portion between the outer surface of the coil and the yoke portion, and the coil film may be thereby damaged. One option for preventing such electrical discharge occurring between the coil and the stator core is, for example, to secure an appropriate creepage distance by increasing the sizes of the flange portions of the insulator, to increase the shortest distances along the surfaces of the flange portions from the outer surface of the coil to the tip of the tooth portion or to the yoke portion. However, increasing the sizes of the flange portions is not preferable because it may increase, for example, the distance in a circumferential direction between adjacent tooth portions in order to prevent adjacent insulators from contacting, and thus, it may increase the size of the overall electric motor.

Therefore, an object of the present invention is to provide an electric compressor capable of preventing electrical discharge occurring between the coil and the stator core, without increasing the size of the overall electric motor.

### Means for Solving the Problem

According to an aspect of the present invention, an electric compressor includes: an electric motor including a cylindrical stator, and a rotor arranged radially inside the stator; and a compression mechanism that is driven by the electric motor, and compresses a refrigerant of a vehicle air conditioner. The stator includes: a stator core including a cylindrical yoke portion, and multiple tooth portions projecting radially inward from an inner peripheral surface of the yoke portion, and arranged at predetermined intervals in a circumferential direction; a rotor arranged radially inside the stator core; a bobbin-shaped insulator removably fitted on each of the multiple tooth portions; a coil wound around the insulator; and an insulating member for covering an outer surface of the coil in a wound state.

### Effects of the Invention

According to the present invention, since the outer surface of each coil wound around each insulator is covered with the insulating member, it is possible to prevent electrical discharge between the coil and the stator core, without increasing the size of the overall electric motor.

### BRIEF DESCRIPTION OF THE DRAWINGS

FIG. 1 is a cross-sectional view of an electric compressor according to an embodiment of the present invention.

FIG. 2 is a side view of a stator.

FIG. 3 is a perspective view of the stator.

FIG. 4 is an exploded perspective view of the stator.

FIG. 5 shows the stator as viewed from the inverter.

FIG. 6 is a cross-sectional view taken along line A-A of FIG. 2.

FIG. 7 is a perspective view of an insulator before a coil is wound therearound.

FIG. 8 is a perspective view of the insulator with a coil wound therearound and covered with an insulating member.

FIG. 9 is a cross-sectional view of the insulator with the coil wound therearound and covered with the insulating member.

### MODE FOR CARRYING OUT THE INVENTION

Hereinbelow, an embodiment of the present invention will be described with reference to the accompanying drawings.

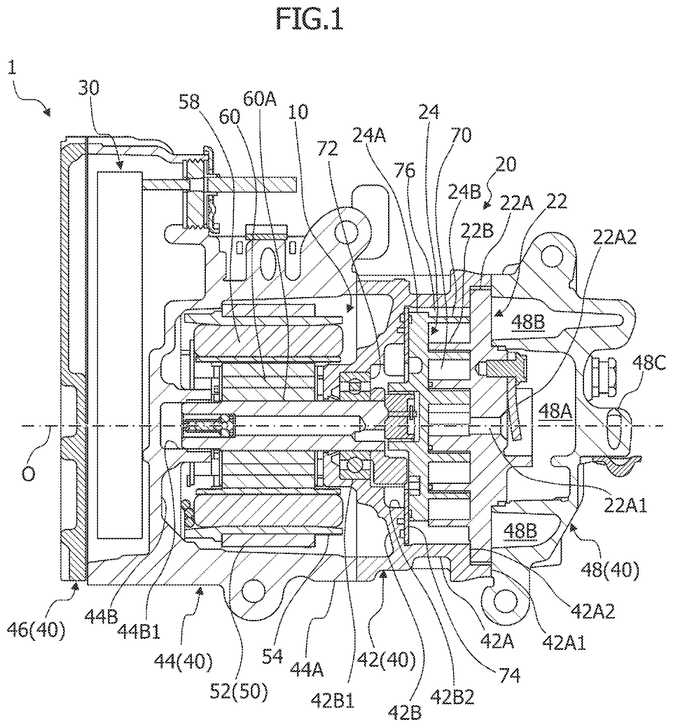

FIG. 1 is a cross-sectional view of an electric compressor according to an embodiment of the present invention.

An electric compressor 1 is provided in a refrigerant circuit of an air conditioner for a vehicle, such as an electric vehicle or a hybrid vehicle. The electric compressor 1 draws therein a refrigerant of the vehicle air conditioner, and compresses and discharges the refrigerant. The electric compressor 1 is a so-called inverter-integrated electric compressor, including: an electric motor 10; a compression mechanism 20 that is driven by the electric motor 10 and compresses a refrigerant of the vehicle air conditioner; an inverter 30 for driving the electric motor 10; and a housing 40 configured to accommodate therein the electric motor 10, the compression mechanism 20, and the inverter 30.

The electric motor 10 includes a cylindrical stator 50, and a rotor 60 arranged radially inside the stator 50. That is, the electric motor 10 is a so-called inner rotor type in which the rotor 60 is arranged radially inside the stator 50. For example, for the electric motor 10, an 8-pole, 12-slot type three-phase alternating current motor may be used.

The stator 50 includes: a bobbin-shaped insulator 54 fitted on each of multiple tooth portions 52A of a stator core 52, described in detail later; a coil 56 (not shown in FIG. 1) wound around the insulator 54; and an insulating member 58 for covering the outer surface of the coil 56 in a wound state.

The rotor 60 has multiple magnetic poles (not shown). More specifically, four N-pole permanent magnets and four S-pole permanent magnets are embedded in the rotor 60. That is, the rotor 60 has eight magnetic poles at even intervals. A through hole (not shown) into which a drive shaft 60A of the electric motor 10 is inserted is formed at the radial center of the rotor 60. The rotor 60 and the drive shaft 60A are integrated by, for example, shrink fitting.

The compression mechanism 20 is arranged at one end of the drive shaft 60A. The compression mechanism 20 is a so-called scroll-type compression mechanism, having, for example, a fixed scroll member 22 and a movable scroll member 24, which are arranged to face each other across the axis O shown in FIG. 1.

The fixed scroll member 22 has a volute wrap 22B integrally formed on an end plate 22A. Similarly, the movable scroll member 24 has a volute wrap 24B integrally formed on an end plate 24A.

The fixed scroll member 22 and the movable scroll member 24 are disposed such that the volute wraps 22B and 24B are engaged so that the protruding end of the volute wrap 22B contacts the end plate 24A and the protruding end of the volute wrap 24B contacts the end plate 22A. In addition, tip seals are embedded in the protruding ends of the volute wraps 22B and 24B.

Furthermore, the fixed scroll member 22 and the movable scroll member 24 are disposed such that side walls of the volute wraps 22B and 24B partially contact each other in a state in which the angles of the volute wraps 22B and 24B differ in a circumferential direction. Thereby, a refrigerant pocket 70, which is a crescent sealed space, is formed between the volute wraps 22B and 24B.

The movable scroll member 24 is connected to one end of the drive shaft 60A, and revolves in a circular orbit around the axis O in a state in which rotation is prevented by an anti-rotation mechanism (not shown). That is, the movable scroll member 24 moves around the fixed scroll member 22 by the rotation of the drive shaft 60A.

The inverter 30 converts a direct current from a vehicle battery (not shown) into an alternating current, and supplies the alternating current to the electric motor 10.

For example, the housing 40 includes: a cylindrical center housing 42 for accommodating the compression mechanism 20; a cylindrical front housing 44 for accommodating the electric motor 10 and the inverter 30, the front housing 44 being arranged in front of the center housing 42 (at the left in FIG. 1); an inverter cover 46 arranged in front of the front housing 44; and a cylindrical rear housing 48 arranged behind the center housing 42 (at the right in FIG. 1), and having a closed rear end. These housings 42, 44 and 48, and the inverter cover 46 are separately formed by, for example, casting, and are integrally fastened by fastening means (not shown), such as bolts, to constitute the housing 40.

The center housing 42 is composed of a hollow cylindrical portion 42A and a bottom wall portion 42B. The compression mechanism 20 is disposed in a space defined by the hollow cylindrical portion 42A and the bottom wall portion 42B on the rear side in the center housing 42. A rear opening of the center housing 42 is closed by the rear housing 48.

The front housing 44 is composed of an annular peripheral wall portion 44A and a partition wall 44B. In the front housing 44, the inverter 30 is arranged in front of the partition wall 44B, and the electric motor 10 is arranged behind the partition wall 44B. A front opening (disposed at the side of the inverter 30) of the front housing 44 is closed by the inverter cover 46.

A through hole 42B1 is formed at substantially the center of the bottom wall portion 42B of the center housing 42. One end of the drive shaft 60A is rotatably supported in the through hole 42B1 by a bearing 72. At substantially the center of the partition wall 44B of the front housing 44, a support portion 44B1 that rotatably supports the other end of the drive shaft 60A is formed. Thereby, the rotor 60 of the electric motor 10 is rotatably supported inside the stator 50 in the radial direction.

Furthermore, a thrust receiving portion 42B2 for receiving the end plate 24A of the movable scroll member 24 via a thrust plate 74 is provided on the bottom wall portion 42B of the center housing 42. The movable scroll member 24 is thereby supported in the thrust direction.

A suction chamber (not illustrated) for a refrigerant is formed inside the front housing 44. The peripheral wall portion 44A of the front housing 44 is provided with a refrigerant suction port (not shown) providing communication from the exterior of the electric compressor 1 to the suction chamber. The heat of the electric motor 10 is radiated using a refrigerant flowing into the suction chamber through the suction port, and the heat of electric components of the inverter 30 are radiated through the partition wall 44B.

Inside the center housing 42 and the front housing 44, a refrigerant passage space 76 is formed. The refrigerant passage space 76 extends in a direction parallel to the axis O, and guides a refrigerant from the suction chamber to the vicinity of the compression mechanism 20.

At the rear end face of the hollow cylindrical portion 42A of the center housing 42, there are formed a first end face 42A1 to which the front end face of the rear housing 48 is joined, and a second end face 42A2 located radially inside the first end face 42A1 and recessed forward in a direction of the axis O. The end plate 22A of the fixed scroll member 22 is held between the second end face 42A2, and the front end face of the rear housing 48.

Here, at substantially the center of the end plate 22A of the fixed scroll member 22, there is formed a discharging hole 22A1 for discharging a refrigerant compressed by the compression mechanism 20, toward the rear housing 48. A one-way valve 22A2 is attached to the discharging hole 22A1. Between the rear housing 48 and the end plate 22A, there is formed a discharge chamber 48A into which a refrigerant discharged through the discharging hole 22A1 flows. Furthermore, a circumferential chamber 48B communicating with the discharge chamber 48A is formed around the discharge chamber 48A. An outer wall of the rear housing 48 is provided with a discharge port 48C for discharging a refrigerant, which has passed through the discharge chamber 48A and the circumferential chamber 48B, to the outside.

Furthermore, for example, an annular gasket (not shown) is interposed between the first end face 42A1 and the front end face of the rear housing 48, and an annular gasket (not shown) is interposed between the end plate 22A and the front end face of the rear housing 48. Similarly, for example, an annular gasket (not shown) is interposed between the front end face of the hollow cylindrical portion 42A of the center housing 42 and the rear end face of the peripheral wall portion 44A of the front housing 44. This prevents leakage of refrigerant from the inside of the housing 40 to the outside.

In the electric compressor 1 configured as described above, when a magnetic field is generated in the stator 50 by power supplied from the inverter 30, a rotational force acts on the rotor 60. The drive shaft 60A is thereby driven to rotate. Then, the rotational force of the drive shaft 60A is transmitted to the movable scroll member 24, to make the movable scroll member 24 move around. The moving movable scroll member 24 compresses a refrigerant in the refrigerant pocket 70, drawn through the suction port, the suction chamber, and the refrigerant passage space 76. The compressed refrigerant is discharged through the discharging hole 22A1 to the discharge chamber 48A, and then, is led therefrom to the outside through the circumferential chamber 48B and the discharge port 48C.

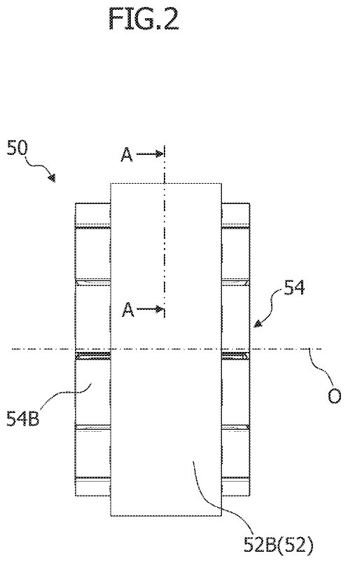

Hereinbelow, the structure of the stator 50 of the electric motor 10 and that of the insulator 54 constituting a part of the stator 50 will be described in detail with reference to FIGS. 2 to 8.

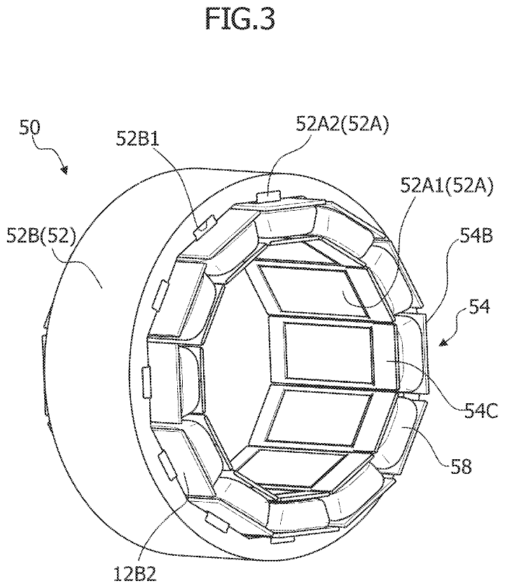

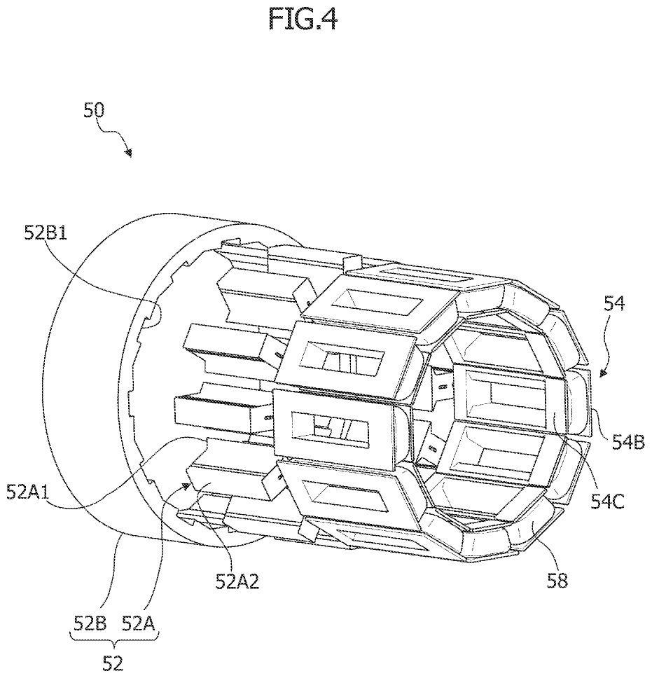

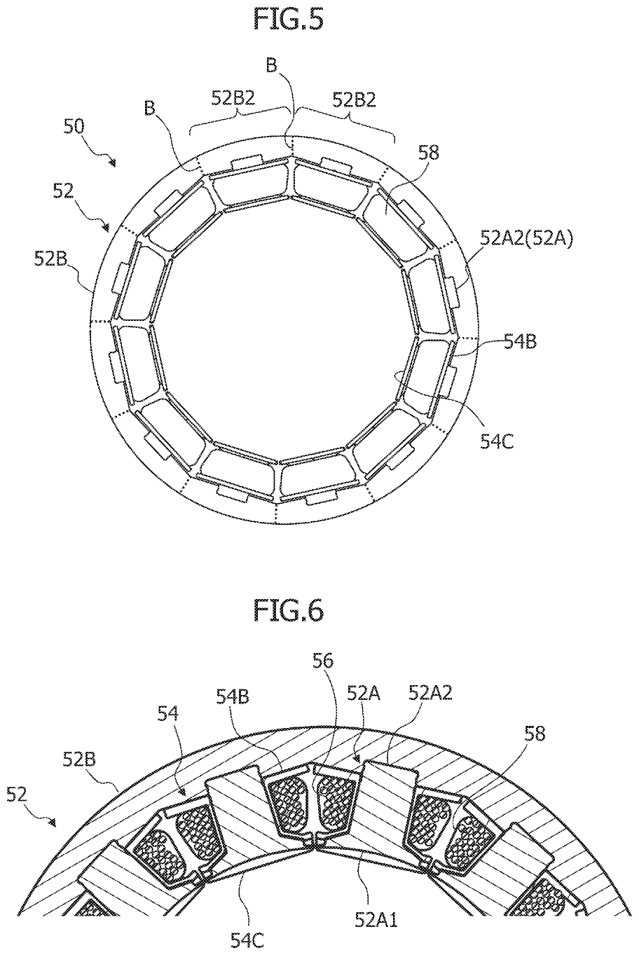

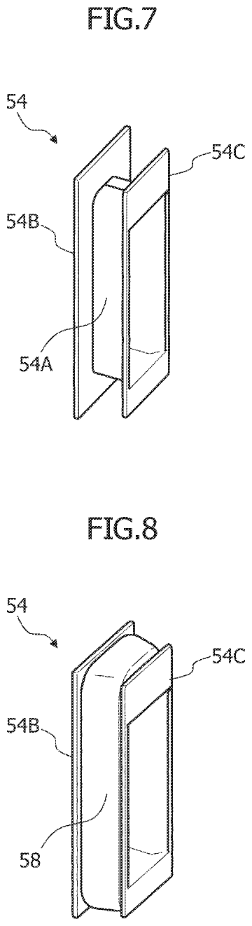

FIG. 2 is a side view of the stator 50, FIG. 3 is a perspective view of the stator 50, FIG. 4 is an exploded perspective view of the stator 50, FIG. 5 shows the stator 50 as viewed from the inverter 30, and FIG. 6 is a cross-sectional view taken along line A-A of FIG. 2. FIG. 7 is a perspective view of the insulator 54 before the coil 56 is wound therearound, and FIG. 8 is a perspective view of the insulator 54 with the coil 56 wound therearound and covered with the insulating member 58. In FIGS. 2 to 4, the compression mechanism 20 is disposed to the left of the stator 50, and the inverter 30 is disposed to the right of the stator 50.

The stator 50 includes a stator core 52, in addition to the abovementioned insulator 54, coil 56, and insulating member 58. The stator core 52 includes a cylindrical yoke portion 52B, and multiple tooth portions 52A projecting radially inward from the inner peripheral surface of the yoke portion 52B, and arranged at predetermined intervals in the circumferential direction. The above-described, 8-pole, 12-slot type, three-phase alternating-current motor includes, for example, twelve tooth portions 52A, and twelve slots open to the rotor 60 between the twelve tooth portions 52A.

Each tooth portion 52A has a radial inner (distal) end (hereinafter, simply referred to as an “inner end”) 52A1, and a radial outer (proximal) end (hereinafter, simply referred to as an “outer end”) 52A2. Each tooth portion 52A is formed by laminating, in a direction of the axis O, substantially T-shaped silicon steel plates formed such that the inner end 52A1 is wider than the outer end 52A2. The tip face of the inner end 52A1 is curved in an arc shape.

For example, the yoke portion 52B may be formed by laminating annular silicon steel plates in a direction of the axis O. As shown in FIG. 4, multiple grooves 52B1 extending in the direction of the axis O and arranged at predetermined intervals in the circumferential direction, are formed on the inner peripheral surface of the yoke portion 52B. Into each groove 52B1, the outer end 52A2 of a tooth portion 52A is press-fitted. That is, the stator core 52 has a divided structure in which the yoke portion 52B and the tooth portions 52A are provided separately.

Although in FIGS. 3 and 4, the yoke portion 52B is shown as an integrally formed hollow cylindrical member, the present invention is not limited thereto. For example, the yoke portion 52B may have a divided structure composed of multiple (e.g., twelve) arc-shaped members 52B2 indicated by dotted lines B in FIG. 5. That is, the cylindrical yoke portion 52B may be composed of the multiple arc-shaped members 52B2 arranged in the circumferential direction and connected to each other. In this case, each tooth portion 52A may be press-fitted into the groove 52B1 of each arc-shaped member 52B2 such that the tooth portion 52A projects radially inward from the inner peripheral surface of the arc-shaped member 52B2.

Furthermore, although in FIGS. 3 to 5, the multiple tooth portions 52A are provided separately, the present invention is not limited thereto. For example, the multiple tooth portions 52A may be formed by connecting the inner ends 52A1 of adjacent tooth portions 52A in the circumferential direction such that the inner peripheral edge defined by the inner ends 52A1 forms a substantially circular shape. In this case, each tooth portion 52A may be press-fitted into a yoke portion 52B in a state in which the outer peripheral edge defined by the outer ends 52A2 forms a gear shape. However, the present invention is not limited thereto, and the multiple tooth portions 52A may be press-fitted into the yoke portions 52B with two or more, but not all of, tooth portions 52A connected. That is, some or all of the multiple tooth portions 52A may be integrally connected at their radial inner ends (inner ends 52A1).

The insulator 54 is a bobbin made of an electrical insulating resin. For example, as shown in FIG. 7, the insulator 54 has: a prismatic tubular body portion 54A that is open at opposite ends; a first rectangular flange portion 54B formed over the entire periphery of an opening edge at one end of the body portion 54A; and a second rectangular flange portion 54C formed over the entire periphery of an opening edge at the other end of the body portion 54A.

The opening of the body portion 54A is formed in a rectangular shape, to fit the body portion 54A on the tooth portion 52A. The first flange portion 54B is configured to be located at a portion corresponding to a radial outer portion of the tooth portion 52A when the body portion 54A is fitted on the tooth portion 52A. The second flange portion 54C is configured to be located at a portion corresponding to a radial inner portion of the tooth portion 52A when the body portion 54A is fitted on the tooth portion 52A. As shown in FIG. 5, in a state in which the insulator 54 is fitted on the tooth portion 52A, the first flange portion 54B is formed to have a greater length along the circumferential direction of the stator core 52 than that of the second flange portion 54C. Furthermore, as shown in FIG. 7, the first flange portion 54B is formed to have a greater length along the axis O direction (the vertical direction in FIG. 7) of the stator core 52 than that of the second flange portion 54C.

Furthermore, as shown in FIG. 6, the inner diameter of a portion of the body portion 54A, corresponding to radially inward portion of the tooth portion 52A, is widened to be adapted to the shape of the inner end 52A1 of the tooth portion 52A. Therefore, in a state in which the insulator 54 is fitted on the tooth portion 52A, the peripheral edge of the inner end 52A1 is surrounded by the inner wall of the body portion 54A.

For example, the coil 56 may be a copper wire coated with an insulating film, and it is wound around the body portion 54A of the insulator 54 (see FIG. 6). As shown in FIG. 8, the outer surface of the coil 56 wound around the insulator 54 (body portion 54A), that is, the outermost exposed surface of the coil 56 in the wound state, is covered with an insulating member 58. Then, the outer end 52A2 of each tooth portion 52A is inserted into the second-flange-portion 54C side opening of each insulator 54, which is in the state shown in FIG. 8. Thereby, the insulator 54 is removably fitted on each tooth portion 52A. In this state, the stator 50 is formed by press-fitting the outer end 52A2 of each tooth 52A into each groove 52B1 of the yoke portion 52B.

For example, the insulating member 58 may be a self-fusing tape made of an electrical insulating resin. It is preferable that the self-fusing tape be a type that has a low adhesive strength during a manufacturing process of the electric motor 10, and has an adhesive surface that melts by heat and adheres (e.g., a heat shrinkable tape), to improve workability in the manufacturing process and to ensure a high vibration resistance required for air conditioners for vehicles. Then, the self-fusing tape is wound around the entire circumference of the coil 56 wound around the insulator 54 (body portion 54A), to thereby cover the outer surface of the coil 56 in the wound state.

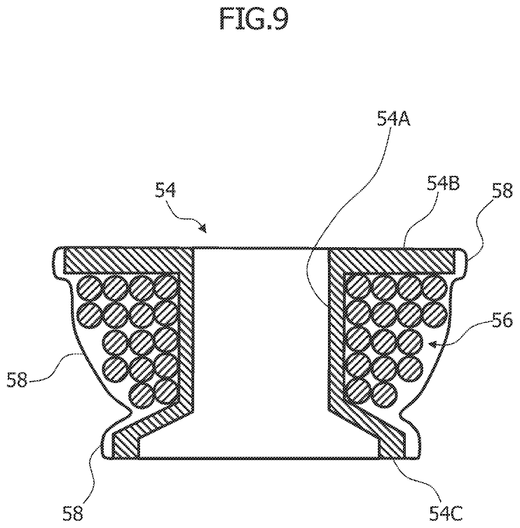

Furthermore, as shown in FIG. 9, it is preferable that the self-fusing tape be wound around the peripheral edge of the first flange portion 54B and the peripheral edge of the second flange portion 54C, in addition to the outer surface of the coil 56 in the wound state. That is, the insulating member 58 may cover the peripheral edges of the first and second flange portions 54B and 54C.

However, the insulating member 58 is not limited to the self-fusing tape. The insulating member 58 may be a coating layer formed by applying an electrical insulating resin to the outer surface of the coil 56 and the peripheral edges of the flange portions 54B and 54C, or by impregnating, with a resin, the entire insulator 54 with the coil 56 wound.

Examples of the resin used for the self-fusing tape and the coating layer, described above, include resins having relatively high heat resistance, oil resistance and refrigerant resistance, in addition to an electrical insulating property, such as polyphenylene sulfide, polytetrafluoroethylene, polyethylene terephthalate, or an epoxy resin.

The electric compressor 1 including the electric motor 10 configured as described above, achieves the following advantageous effects.

That is, since the outer surface of the coil 56 wound around the tooth portion 52A of the stator core 52 via the insulator 54 is covered with the insulating member 58, an exposed surface of the coil 56 to the stator core 52 is eliminated. Thus, even if a relatively high voltage is applied to the electric motor 10, it is possible to prevent electrical discharge that is a flow of a current along the surfaces of the flange portions 54B and 54C of the insulator 54 occurring between the outer surface of the coil 56 and the stator core 52. More specifically, it is possible to electrically insulate components without considering creepage distances, which are the shortest distance along the surface of the second flange portion 54C from the outer surface of the coil 56 to the inner end 52A1 of the tooth portion 52A, and the shortest distance along the surface of the first flange portion 54B from the outer surface of the coil 56 to the yoke portion 52B. Furthermore, since there is no need to secure a clearance for insulation (especially, a creepage distance) between the coil 56 and the stator core 52, which may be required when a relatively high voltage is applied to the electric motor 10, there is no need to increase the sizes of the flange portions 54B and 54C. Therefore, since there is no need to increase the circumferential distance between adjacent tooth portions 52A in order to prevent adjacent insulators 54 from contacting, which may be caused by increasing the sizes of the flange portions 54B and 54C, it is possible to prevent the abovementioned electrical discharge without increasing the size of the overall electric motor 10.

Furthermore, typically, in electric motors, electrical discharge can occur not only between the coil and the stator core, but also between adjacent coils. However, in the electric motor 10 configured as described above, since the outer surface of the coil 56 in the wound state is covered with the insulating member 58, it is also possible to prevent electrical discharge occurring between adjacent coils 56. Therefore, it is possible to reduce the size of the overall electric motor 10 by reducing the circumferential distance between adjacent tooth portions 52A.

Furthermore, the insulating member 58 covers the entire circumference of the outer surface of the coil 56 wound around each tooth portion 52A via the insulator 54. Thus, in the electric compressor 1, the coil 56 is thereby electrically insulated from the components of the electric compressor 1 that are located near the coil 56, such as the peripheral wall 44A and the partition wall 44B of the front housing 44, and the bottom wall portion 42B of the center housing 42. Therefore, since it is possible to prevent electrical discharge occurring between the coil 56 and the components of the electric compressor 1, this makes it possible to reduce the size of the overall electric compressor 1 by, for example, reducing the accommodation space in the housing 40.

In the above description, in addition to the outer surface of the coil 56 in the wound state, the peripheral edges of the first and second flange portions 54B and 54C of the insulator 54 are covered with the insulating member 58. This makes it possible to more effectively eliminate a gap between the coil 56 and the first and second flange portions 54B and 54C. Therefore, it is possible to effectively prevent electrical discharge that is a flow of a current between the outer surface of the coil 56 and the inner end 52A1 of the tooth portion 52A or the yoke portion 52B, along the surfaces of the flange portions 54B and 54C, which may occur by a current passing through the gap.

Furthermore, in the above description, the stator core 52 has the divided structure in which the yoke portions 52B and the tooth portions 52A are provided separately. Furthermore, the insulator 54 is removably fitted on each tooth portion 52A. Therefore, when maintenance of the electric motor 10 is performed or when the coil 56 is damaged, it is possible to remove the tooth portions 52A from the yoke portion 52B, to inspect the insulators 54 removed from the tooth portions 52A, and to replace with a new insulator 54 around which a new coil 56 is wound.

The embodiment as shown in the drawings is intended to merely illustrate the present invention, and it is a matter of course that the present invention encompasses various improvements and modifications that may be made by one skilled in the art within the scope of the appended claims, in addition to those directly illustrated by the embodiment described above.

### REFERENCE SYMBOL LIST

1 Electric compressor
10 Electric motor
50 Stator
52 Stator core
52A Multiple tooth portions
52A1 Inner end
52B Yoke portion
52B2 Arc-shaped member
54 Insulator
54A Body portion
54B First flange portion
54C Second flange portion
56 Coil
58 Insulating member
60 Rotor

1. An electric compressor comprising:
an electric motor including a cylindrical stator, and a rotor arranged radially inside the stator; and
a compression mechanism that is driven by the electric motor, and compresses a refrigerant of a vehicle air conditioner,
wherein the stator comprises:
a stator core including a cylindrical yoke portion, and multiple tooth portions projecting radially inward from an inner peripheral surface of the yoke portion, and arranged at predetermined intervals in a circumferential direction,
a bobbin-shaped insulator removably fitted on each of the multiple tooth portions,
a coil wound around the insulator; and
an insulating member for covering an outer surface of the coil in a wound state.

2. The electric compressor according to claim 1, wherein the insulator comprises:
a tubular body portion that is open at opposite ends, and is configured to fit on each of the multiple tooth portions with the coil wound around the body portion,
a first flange portion extending outward from an opening edge of the body portion at a portion corresponding to a radial outer portion of the tooth portion; and
a second flange portion extending outward from an opening edge of the body portion at a portion corresponding to a radial inner portion of the tooth portion,
wherein the insulating member covers each peripheral edge of the first flange portion and the second flange portion, in addition to the outer surface of the coil in the wound state.

3. The electric compressor according to claim 1 or 2, wherein the insulating member is a self-fusing tape or a coating layer, made of an electrical insulating resin.

4. The electric compressor according to claim 3, wherein the resin is polyphenylene sulfide, polytetrafluoroethylene, polyethylene terephthalate, or an epoxy resin.

5. The electric compressor according to claim 1, wherein the stator core has a divided structure in which the yoke portion and the multiple tooth portions are provided separately.

6. The electric compressor according to claim 1, wherein the cylindrical yoke portion is composed of multiple arc-shaped members arranged in the circumferential direction and connected to each other.

7. The electric compressor according to claim 1, wherein some or all of the multiple tooth portions are integrally connected at radial inner ends.

8. The electric compressor according to claim 2, wherein the insulating member is a self-fusing tape or a coating layer, made of an electrical insulating resin.

9. The electric compressor according to claim 8, wherein the resin is polyphenylene sulfide, polytetrafluoroethylene, polyethylene terephthalate, or an epoxy resin.

10. The electric compressor according to claim 2, wherein the stator core has a divided structure in which the yoke portion and the multiple tooth portions are provided separately.

11. The electric compressor according to claim 3, wherein the stator core has a divided structure in which the yoke portion and the multiple tooth portions are provided separately.

12. The electric compressor according to claim 4, wherein the stator core has a divided structure in which the yoke portion and the multiple tooth portions are provided separately.

13. The electric compressor according to claim 2, wherein the cylindrical yoke portion is composed of multiple arc-shaped members arranged in the circumferential direction and connected to each other.

14. The electric compressor according to claim 3, wherein the cylindrical yoke portion is composed of multiple arc-shaped members arranged in the circumferential direction and connected to each other.

15. The electric compressor according to claim 4, wherein the cylindrical yoke portion is composed of multiple arc-shaped members arranged in the circumferential direction and connected to each other.

16. The electric compressor according to claim 5, wherein the cylindrical yoke portion is composed of multiple arc-shaped members arranged in the circumferential direction and connected to each other.

17. The electric compressor according to claim 2, wherein some or all of the multiple tooth portions are integrally connected at radial inner ends.

18. The electric compressor according to claim 3, wherein some or all of the multiple tooth portions are integrally connected at radial inner ends.

19. The electric compressor according to claim 5, wherein some or all of the multiple tooth portions are integrally connected at radial inner ends.

20. The electric compressor according to claim 6, wherein some or all of the multiple tooth portions are integrally connected at radial inner ends.
